(19) United States
(12) Patent Application Publication
(10) Pub. No.: US 2026/0229143 A1
(43) Pub. Date: Aug. 6, 2026

(54) Accelerating Motor Learning and Skills Acquisition in Sports Using Robotics

(71) Applicant: The Trustees of Columbia University in the of New York, New York, NY (US)

(72) Inventor: Sunil K. AGRAWAL, Newark, DE (US)

(73) Assignee: The Trustees of Columbia University in the City of New York, New York, NY (US)

(21) Appl. No.: 19/464,917

(22) Filed: Jan. 30, 2026

Related U.S. Application Data
(60) Provisional application No. 63/752,222, filed on Jan. 31, 2025.

(51) Int. Cl. G09B 19/00; A63B 24/00; A63B 69/00; A63B 71/06; A63B 102/18

(52) U.S. Cl. CPC G09B 19/0038; A63B 24/0003; A63B 69/0002; A63B 2069/0006; A63B 71/0622; A63B 2102/18; A63B 2214/00

(57) ABSTRACT

Subjects can be trained to optimize their performance in a sport based on a motion data template obtained from experts at that sport. The motion data template indicates how the experts move their trunks and pelvis (and optionally additional points on their body) while performing particular tasks. A plurality of cables are affixed to a subject's pelvis and torso. Actuators exert synchronized pull forces on these cables in order to apply synchronized forces to the subject's pelvis and the subject's torso while the subject performs the task. These synchronized forces are configured to help teach the subject how to move their body in a way that resembles the experts' movements.

### CROSS REFERENCE TO RELATED APPLICATIONS

This application claims the benefit of U.S. Provisional Application 63/752,222, filed Jan. 31, 2025, which is incorporated herein by reference in its entirety.

### BACKGROUND

Prior art rehabilitation robotics rely on programmable sensors and actuators, worn externally on the human body. The robotics apply external forces on the body segments, or control their motion, sometimes in response to sensed motion of the body and physiological signals, such as muscle EMGs, brain EEG, and heart vitals. Rehabilitation robotics are typically designed to improve a specific deficiency in a human function.

Columbia University's Robotics and Rehabilitation Laboratory has demonstrated the effectiveness of rehabilitation robotics in everyday human functions such as walking, reaching with the trunk and arms, head-neck control, etc. The human subjects in these studies were both healthy subjects and those with brain injury, such as with stroke, spinal cord injury, cerebral palsy, and others. For example, “Robotic upright stand trainer (RobUST) and postural control in individuals with spinal cord injury”, The Journal of Spinal Cord Medicine, 2023 by Collin D Bowersock et al. describes a rehabilitation system that uses cables to apply forces to a subject's trunk and pelvis. The RobUST system is used to provide assistance-as-needed at the trunk while individuals with spinal cord injury performed stable standing and self-initiated trunk movements. The RobUST system can measure pressure center, balance, and electromyographic signals, while applying controlled forces on the pelvis and trunk.

### SUMMARY OF THE INVENTION

One aspect of this application is directed to a first system for teaching a person how to move their body in a particular way that includes plurality of first cables, a plurality of second cables, first and second fasteners, a plurality of first actuators, a plurality of second actuators, and a controller. The first fastener is configured to fasten the plurality of first cables to the person's pelvis, and the second fastener is configured to fasten the plurality of second cables to the person's torso. Each of the plurality of first actuators is configured to, when actuated, exert a pull force on a respective one of the first cables. And each of the plurality of second actuators is configured to, when actuated, exert a pull force on a respective one of the second cables. The controller is configured to generate a sequence of commands that results in a synchronized actuation of the plurality of first actuators and the plurality of second actuators. The synchronized actuation of the plurality of first actuators and the plurality of second actuators causes corresponding synchronized pull forces to be applied to the plurality of first cables and the plurality of second cables, respectively. The synchronized pull forces applied to the plurality of first cables and the plurality of second cables cause corresponding synchronized forces to be applied to the first fastener and the second fastener, respectively. The synchronized forces applied to the first fastener and the second fastener cause corresponding synchronized forces to be applied to the person's pelvis and the person's torso, respectively. And the sequence of commands is selected so the forces applied to person's pelvis and the person's torso help teach the person how to move their body in the particular way.

In some embodiments of the first system, the plurality of first actuators comprises a plurality of first motors, and the plurality of second actuators comprises a plurality of second motors.

Some embodiments of the first system further comprise a first force plate configured for positioning beneath a first foot of the person. In these embodiments, the first force plate generates first data that is routed to the controller, and the controller is further configured to modify the generated sequence of commands based on the first data.

Some embodiments of the first system further comprise first and second force plates configured for positioning beneath first and second feet of the person, respectively. The first and second force plates respectively generate first and second data that is routed to the controller. And the controller is further configured to modify the generated sequence of commands based on the first data and the second data.

In some embodiments of the first system, the sequence of commands is selected so the forces applied to the person's pelvis and the person's torso will help the person learn how to do a particular task that requires coordination of the person's upper body and the person's lower body.

In some embodiments of the first system, the sequence of commands is selected to provide assist-as-needed forces to the person's pelvis and the person's torso, wherein the assist-as-needed forces help the person learn how to do a particular task that requires coordination of the person's upper body and the person's lower body.

In some embodiments of the first system, the sequence of commands is selected so the forces applied to person's pelvis and the person's torso will help the person learn how to do a particular sport-related task.

In some embodiments of the first system, the sequence of commands is selected so the forces applied to the person's pelvis and the person's torso will help the person learn how to do a particular yoga move.

Another aspect of this application is directed to a first method of training a subject to perform a particular task. The first method comprises creating a first motion template of the pelvic and trunk centers of a plurality of experts while they perform the particular task; recording movement patterns of the subject's pelvis and the subject's trunk while the subject performs the particular task; and training the subject to coordinate their trunk and pelvis motions by providing assist-as-needed forces on the subject's pelvis and the subject's trunk. The assist-as-needed forces are based at least in part on the first motion template and the recorded movement patterns of the subject's pelvis and the subject's trunk.

Some instances of the first method further comprise comparing pre-training and post-training movements of the subject's pelvis and the subject's trunk to quantify the subject's learning.

Some instances of the first method further comprise creating a second motion template of at least one additional reference point on the bodies of the plurality of experts while they perform the particular task; and recording movement patterns of the at least one additional reference point while the subject performs the particular task. The assist-as-needed forces are based at least in part on the second motion template and the recorded movement patterns of the at least one additional reference point.

### BRIEF DESCRIPTION OF THE DRAWINGS

FIG. 1a depicts a sports training system.

FIG. 1b depicts the FIG. 1a sports training system being used by a subject.

FIG. 2a depicts an experimental protocol.

FIG. 2b is a planar representation of an ellipse trace training exercise.

FIG. 3a depicts the functional reach test, in which participants reached as far as possible with their hand in three directions.

FIG. 3b depicts the Y balance test, involving maximal reach with each foot in three directions.

FIG. 3c depicts a test in which participants reach with their thorax in eight directions.

FIG. 3d depicts an ellipse trace test in which participants followed a planar trajectory with their thorax.

FIG. 4a depicts a thorax trajectory in the horizontal plane and a corresponding pelvis trajectory for a single subject.

FIG. 4b shows the thorax trajectory in the horizontal plane and the resulting prescribed pelvis trajectory, computed using a regression model.

FIG. 5a depicts learning curves fitted to the sizes of ellipses during training for subjects from three different groups of subjects.

FIGS. 5b-5e respectively depict four different parameters for the three different groups of subjects.

FIG. 6 depicts the results of a functional reach test.

FIG. 7 depicts the results of a Y balance test.

FIGS. 8a and 8b respectively show the average group smoothness of the trajectories traced by subjects' thorax and pelvis.

FIG. 8c shows the ellipse trace accuracy/error.

FIG. 8d shows the log dimensionless jerk smoothness of ellipse trace trajectory at several ellipse sizes.

FIG. 9 shows continuous relative phase CRP standard deviation at different ellipse scaling ratios.

### DESCRIPTION OF THE PREFERRED EMBODIMENTS

It has heretofore been rather difficult to teach most people how to move their body in a manner that will optimize their performance in a sport. For even tasks that initially might appear to be relatively simple (such as throwing a baseball) actually involve the synchronized actuation of many different muscles in the subject's body including but not limited to both legs, the abdominals, both arms, and the shoulders. It also involves a number of shifts in the subject's center of gravity. And simply watching another person perform a sports-related task is almost never enough to teach a novice how to perform that task.

Like the prior art RobUST system, the embodiments described herein use cables to apply forces to a subject's trunk and pelvis, and monitor what the subject's body is doing (e.g., by measuring pressure center, balance, and electromyographic signals). But instead of applying forces to the trunk and pelvis in order to accomplish rehabilitation, the embodiments described herein use cables to apply forces to a subject's trunk and pelvis to teach a subject how to move their body in a particular way in order to improve the person's performance in a sport.

In some preferred embodiments, the system is programmed based on data obtained from expert players in the relevant sport. Thus, to teach a person how to throw baseball for relatively short distances (e.g., 20 m), the system can be trained based on data obtained from star shortstops. And to teach a person how to throw a baseball for relatively long distances (e.g., 80 m), the system can be trained based on data obtained from star outfielders.

Applying forces to the subject's torso and pelvis while the subject attempts to perform the relevant task (e.g., throwing a baseball) will help the subject learn how to improve their performance at that task much faster than simply watching star players carry out the same task. In other words, by applying forces to a subject's torso and pelvis to guide a person's body to move in an optimized way while they are performing a given task, the principles of motor learning will enable the subject to learn how to perform the task much faster than would otherwise be possible.

The system can also quantify human learning, and develop AI/ML models. By having novices and experts perform tasks that require coordination of the upper and lower body, movement patterns and motion templates of the pelvic and trunk center can be created. Assist-as-needed-forces on the pelvis and trunk are subsequently applied to train novices to coordinate the trunk and pelvis. This technology can be utilized as robotic-mediated training for performance improvement and injury mitigation. A virtual reality environment can also be provided to visually show the outcomes that result from their movements. Discussions with knowledgeable people (e.g., coaches, ball players, etc.) can help define the specifics of this virtual reality environment for training.

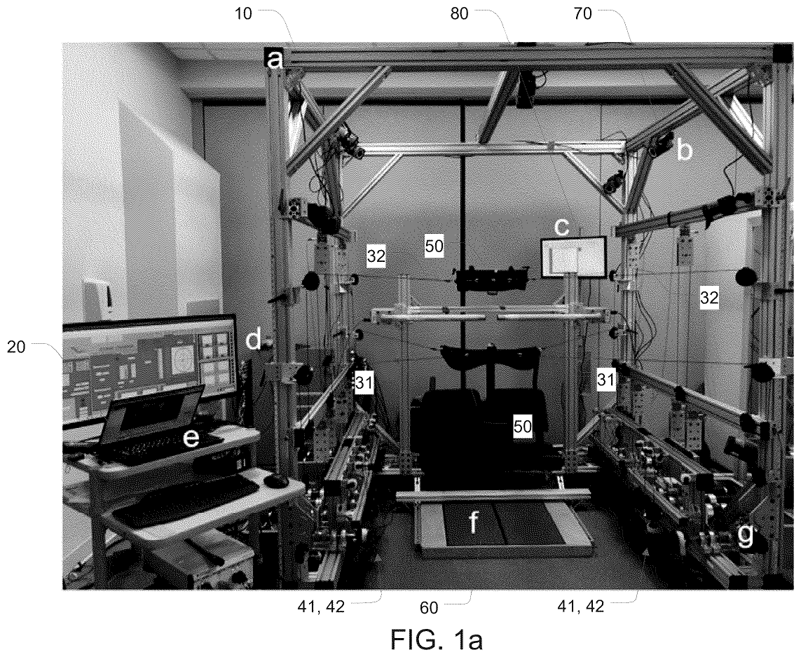

FIG. 1a depicts a sports training system. The system uses cables 31-32 to apply forces to a subject's trunk and pelvis, and monitor what the subject's body is doing (e.g., by measuring pressure center, balance, and electromyographic signals). The applied forces are orchestrated to teach a subject how to move their body in a particular way in order to improve the person's performance in the relevant sport.

The system is integrated with a motion capture system 70 and force plates 60, as well as fasteners 50 worn at the pelvis and the trunk that can apply controlled forces and moments. In the examples described below, the fasteners 50 are belts. But in alternative embodiments (not shown), alternative types of fasteners (e.g., harnesses, straps, etc.) can be used. The forces are applied to the pelvis fastener 50 and the trunk fastener 50 via cables 31-32. A motion capture system 70 records key points on the human body during the game. One example of a suitable motion capture system 7D is the nine-camera VICON motion capture system (Vicon, Denver, CO). But a wide variety of alternative motion capture systems can also be used. The force plates 60 under the feet record the center of pressure to provide measures of balance during the task. One example of a suitable set of forest plates 60 is the Bertec six-axis force plate (Bertec, Columbus, OH). A wide variety of alternative force plates can also be used.

One example of a system for teaching a person how to move their body in a particular way includes a plurality of first cables 31 and a plurality of second cables 32, first and second fasteners 50, a plurality of first actuators 41 and a plurality of second actuators 42, and a controller 20. In the example depicted in FIG. 1a, the actuators 41-42 are motors (e.g., Maxon motors). But in alternative embodiments, a wide variety of alternative actuators can be used. The first fastener 50 is configured to fasten the plurality of first cables 31 to the person's pelvis, and the second fastener 50 is configured to fasten the plurality of second cables 32 to the person's torso. The plurality of first actuators 41 and the plurality of second actuators 42 are configured to, when actuated, exert pull forces on the plurality of first cables 31 and the plurality of second cables 32, respectively. The actuators 41-42 are affixed to a frame 10 that is big enough for adult human subjects to fit within the frame. Optionally, a display 80 may be positioned in front of the subject to provide visual feedback to the subject. Alternatively, a virtual reality headset can be used to provide visual feedback to the subject.

The controller 20 is configured to generate a sequence of commands that results in a synchronized actuation of the plurality of first actuators 41 and the plurality of second actuators 42. The synchronized actuation of the plurality of first actuators and the plurality of second actuators causes corresponding synchronized pull forces to be applied to the plurality of first cables 31 and the plurality of second cables 32, respectively. The synchronized pull forces applied to the plurality of first cables and the plurality of second cables cause corresponding synchronized forces to be applied to the first fastener 50 and the second fastener 50, respectively. The synchronized forces applied to the first fastener and the second fastener cause corresponding synchronized forces to be applied to the person's pelvis and the person's torso, respectively. And the sequence of commands is selected so the forces applied to person's pelvis and the person's torso help teach the person how to move their body in the particular way.

In some embodiments, the plurality of first actuators 41 and the plurality of second actuators 42 comprise a plurality of first motors and a plurality of second motors, respectively.

Some embodiments further comprise a first force plate 60 configured for positioning beneath a first foot of the person. In these embodiments, the first force plate 60 generates first data that is routed to the controller 20, and the controller is further configured to modify the generated sequence of commands based on the first data.

Some embodiments further comprise first and second force plates 60 configured for positioning beneath first and second feet of the person, respectively. The first and second force plates 60 respectively generate first and second data that is routed to the controller 20. And the controller is further configured to modify the generated sequence of commands based on the first data and the second data.

In some embodiments, the sequence of commands is selected so the forces applied to the person's pelvis and the person's torso will help the person learn how to do a particular task that requires coordination of the person's upper body and the person's lower body.

In some embodiments, the sequence of commands is selected to provide assist-as-needed forces to the person's pelvis and the person's torso, wherein the assist-as-needed forces help the person learn how to do a particular task that requires coordination of the person's upper body and the person's lower body.

In some embodiments, the sequence of commands is selected so the forces applied to person's pelvis and the person's torso will help the person learn how to do a particular sport-related task.

In some embodiments, the sequence of commands is selected so the forces applied to the person's pelvis and the person's torso will help the person learn how to do a particular yoga move.

Optionally, electromyographic (EMG) signals from the muscle groups within the lower body and the upper body relevant to the task are recorded and monitored. Optionally, electroencephalogram (EEG) signals (e.g., obtained from a cap worn by the subject) can also be recorded and monitored. The system applies controlled forces on the pelvis and the trunk by controlling, in real-time, tensions in the cables 31-32 to result in specific force/torque profile on the trunk and the pelvis.

While a number of training studies can be performed involving this system, the system is being described herein in the context of catch and throw tasks that require coordination of the upper and lower body. Such tasks are quite important in different ball games, including cricket, baseball, and American football.

One suitable procedure for training individuals with a complex movement using robotics is as follows: (i) record movement patterns of key points on the human body, including the pelvis and the trunk, during specific virtual reality catch and throw tasks in a sport from two groups, i.e., novices and experts; (ii) create motion templates of the pelvic and trunk centers (mean±standard deviation) for the two groups to show that differences exist in the motion templates of novices and experts; (iii) train each individual in the novice group to coordinate the trunk and pelvis motions using the data from the experts by providing assist-as-needed forces on the pelvis and the trunk using the robotic system; (iv) compare pre-training and post-training movements of the key points to quantify learning and explain using data from force plates 60 and EMG from lower and upper body; (v) develop an AI/ML model using the data from the experiments, collected over subjects and training sessions, that characterizes the human learning.

One suitable approach for testing the system is described below. Two groups of 20 individuals, consisting of novices and experts will be recruited to participate in the study. The virtual reality will be programed in Unity with the task to be learnt. The appropriateness of the task will be verified by expert ball players. Each member of the two groups will perform the task and data will be recorded using motion capture, force plates 60, and EMG sensors. All data will be cut into movement cycles and time scaled from 0 to 1. The movement data will be normalized by the subject height and averaged to get the mean and standard deviation across the groups.

Each member of the novice group will be invited again and the system will be programed with an assist-as-needed force field for the training study. Each subject would perform 12 bouts of training with the task, with each bout containing 10 repetitions. The subjects will get a 5 minutes rest after every 3 bouts of practice. Once the training is complete, the subjects will be asked to make the movements again but without the system's assistance. This evaluation will be repeated after 10 minutes and 2 hours to characterize learning and retention of the trained movement. The data from pre-training, post-training, 10 minutes post-training, and 2 hours post-training will be compared to characterize learning. The data from force plates 60, EMGs, and forces applied by the system will be used to build mechanistic models of how subjects learned with robot-assisted training. For a long-term learning, this procedure can be repeated several times a week for an appropriate training windows that may last over months or years.

### Proof of Concept

The remainder of this application describes a set of experiments that provides proof-of-concept that robotic assistance applied concurrently at the thorax and pelvis can help a person acquire body-movement skills that can be helpful in the context of training (e.g., for sports, yoga, etc.) as well as for rehabilitation. And although the experiments involved relatively simple tasks like enhancing participants' reaching performance, these concepts can be extended to more complicated tasks including but not limited to sports-related tasks (e.g., throwing a ball), doing yoga moves, etc.

We investigated training strategies in healthy participants to establish a baseline for future applications. Twenty-four individuals were assigned to one of three groups: (i) control, without assistance (Ctrl), (ii) robotic assistance at the trunk, specifically at the thorax (T), and (iii) robotic assistance applied concurrently at the thorax and pelvis (T-P). Training was delivered using the Robotic Upright Stand Trainer (RobUST), which provides assist-as-needed forces based on deviations from target trajectories and normative thorax-pelvis coordination patterns. Participants were trained to perform elliptical thorax movements while standing, a task with progressively increasing postural demands. Results showed that T-P assistance enabled participants to achieve larger ellipse sizes during training compared to T assistance, suggesting that pelvic support facilitated greater exploration of range of motion. Post-training, ellipse tracing accuracy improved in all groups, but only the T-P and Ctrl groups demonstrated significant gains in movement smoothness. Learning-curve analysis further revealed that while T-P participants required a longer acclimatization period, they ultimately achieved higher combined learning metrics than the T group. These findings highlight the potential of trunk-pelvis coordinated assistance to promote greater improvements in postural control or sports training than assistance limited to the trunk. The results provide a foundation for developing trunk-pelvis interventions aimed at improving postural control or implementing movement training (e.g., for sports, yoga, etc.).

### Introduction

During most functional activities, trunk motion is intrinsically coupled with pelvic motion, and together these segments play a central role in maintaining balance and facilitating complex upper-body movements. Interventions that promote coordinated trunk-pelvis movement are therefore critical for improving postural control and functional performance.

There are two main elements to upright human standing-(i) the continuous activation of lower-body muscles to generate joint torques that prevent buckling under gravity, and (ii) the coordination of these joint torques to position the center of mass (COM) within the base of support (BOS). Reaching tasks engage both of these mechanisms to move a body segment (the hand, chest, or COM) toward a target from a neutral posture. The extent of a reach depends on the magnitude of the joint torques a person can generate and is constrained by biomechanical limits. The center of pressure (COP), representing the location of the ground reaction force, is confined to the BOS at the feet. Anatomically, the thorax and pelvis are approximately 18% and 15% of the total body weight, respectively, and substantially influence the location of the COM. Their motion also affects the position of the upper and lower extremities, which together represent an additional 10% and 35% of body mass. Consequently, we hypothesize that improving the coordination between the trunk and pelvis will enhance functional reach and postural stability.

During reaching tasks, individuals can adopt one of three postural strategies: an ankle strategy, a hip strategy, or a mixed strategy. These strategies describe how an individual coordinates body movements around the ankles and hips to achieve postural stability. For example, in the forward reach, the ankle strategy involves ankle dorsiflexion and minimal hip flexion, typically less than 15°. In contrast, the hip strategy primarily engages ankle plantarflexion with greater hip flexion, whereas the mixed strategy combines both, initiating with ankle dorsiflexion but with hip flexion exceeding 15°. Each strategy serves distinct purposes depending on task demands, influencing the configuration and coordination of the thorax and pelvis. The ankle strategy is typically used for slow, short-range movements, while the hip strategy is used during faster or longer reaches. Previous studies have shown that the reach distance is significantly greater with the hip strategy than with the ankle strategy. This increase arises from the coordinated rotation of body segments, which enables dynamic balance through compensatory joint torques that counteract those produced during forward reaching. This rationale motivates the present study, which focuses on training the coordination between the thorax and pelvis to enhance participants' reaching performance.

The importance of the thorax-pelvis relationship has been widely recognized. At lower walking speeds, transverse rotations of the pelvis and thorax tend to be in phase, while they move progressively out of phase by up to 120 degrees at higher velocities. This anti-phase relationship is thought to minimize the whole-body angular momentum and stabilize forward progression. Pelvic rotation induced by leg motion is counteracted by the opposite trunk rotation, thereby stabilizing the head and maintaining sensory orientation in space. Thus, the pelvis and thorax work in concert to achieve whole-body stability. Beyond walking, this coordination is equally important in upper-body tasks. Indeed, the risk of lower back injury has been reported when pelvic rotation is restrained during reaching tasks, emphasizing the need for training scenarios that permit concurrent movement of the pelvis and thorax.

Robot-assisted training programs have shown superior improvements in quantitative measures of trunk control and balance compared to conventional physical therapy. By providing sensory feedback and physical assistance, robotic devices can expand the range of motion and enhance postural control beyond previous limits of stability. However, most prior approaches have overlooked the potential of training trunk movement along with the pelvis despite the essential role the pelvis plays in facilitating complex and natural whole body motions. To our knowledge, no prior study has explicitly sought to train the trunk and pelvis simultaneously. For example, the Trunk Support Trainer (TruST) has been used for seated training, actuating only the trunk via cable mechanisms. The Lokomat system targets lower-limb movements at the hips and knees, while other devices similarly focus on the lower body without actively coordinating upper and lower segment motion.

The ROAR Lab at Columbia University has developed a cable-driven exoskeleton called the Robotic Upright Stand Trainer (RobUST), which can independently actuate the thorax and pelvis. In RobUST, the subject wears two belts: one around the thorax and another around the pelvis, each connected to multiple motor-driven cables configured to apply forces in the horizontal plane at the thorax and in any direction on the pelvis. RobUST provides a safe, controlled environment for training postural balance control in individuals with or without motor impairments. Owing to its cable-driven design, RobUST introduces minimal inertia and does not constrain the natural range of motion of the participant's joints.

The effectiveness of RobUST as a balance training device has been demonstrated in several studies where participants were assisted at the thorax while receiving rigid support at the pelvis. In individuals with spinal cord injury (SCI), hands-free training using RobUST led to increased lower-limb muscle activation and improved independent trunk control during and after training. These results were achieved by providing assist-as-needed support at the thorax and fixed support at the pelvis. We hypothesize that supplementing this configuration with guided pelvic motion can further enhance balance training outcomes.

In the present study, we examine the effectiveness of a coordinated thorax-pelvis robotic assistance paradigm for improving healthy participants' movements. We compare outcomes from this condition against two alternatives: (1) no robotic assistance and (2) assistance provided only at the thorax. We hypothesize that participants receiving thorax-pelvis assistance will exhibit superior improvements in postural control metrics relative to the other two conditions.

Robotic assistance positioned the thorax and pelvis to enable an extended reach, allowing participants to experience the mechanics of greater excursion while still exerting effort to attain and maintain their posture. In this way, the task provides functional practice at increasingly larger ranges of motion while engaging the trunk-pelvis system under realistic stability demands. For individuals with SCI, motor control is typically impaired from the lesion level downward, affecting both trunk and lower-limb function. Training paradigms that involve weight bearing and active weight shifting, as implemented in this study, have the potential to strengthen residual neuromuscular control in the lower body. Such integrated trunk-pelvis tasks may therefore represent a promising approach to improving postural stability and balance in SCI populations. For healthy individuals, analogous processes will help train subjects to perform whatever motion they are trying to improve.

The ellipse tracing task was employed to drive this training process. The task required continuous coordinated positioning of the thorax and pelvis to reach and trace the elliptical boundary. Task difficulty was progressively increased by modulating the ellipse size according to each participant's performance. Assist-as-needed force fields were applied at the trunk and/or pelvis when movement errors from predefined path templates exceeded set thresholds. The objective was to use these thorax and pelvis templates to guide subjects during ellipse tracing, challenging them to perform controlled movements over larger excursions than at baseline. Progressively increasing task difficulty can also be helpful in the context of sports training.

### Methods

### Experimental Protocol

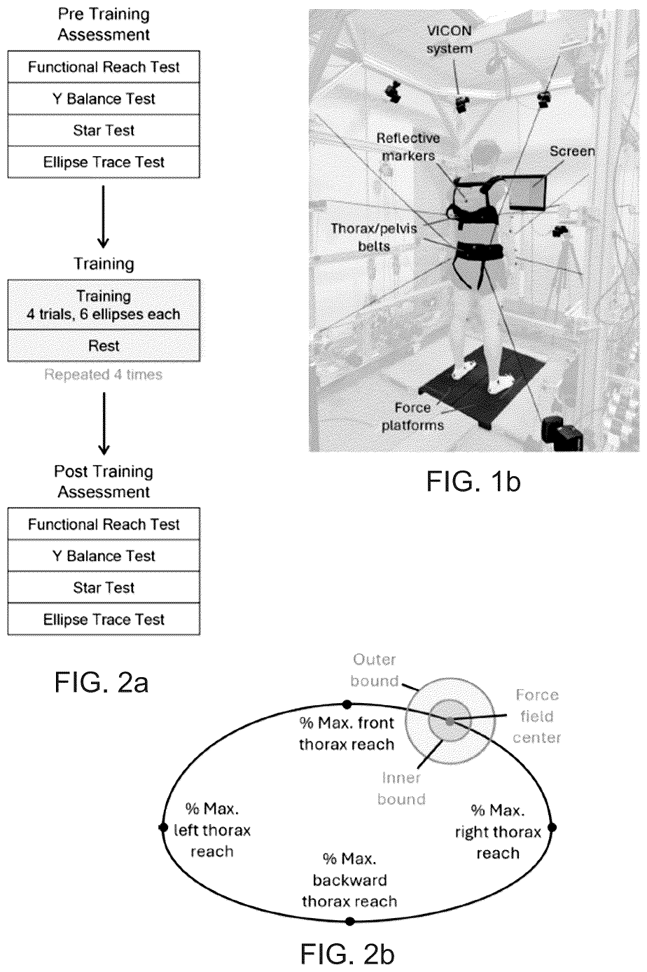

FIG. 2(a) depicts the protocol of the experiment. Healthy adults were recruited as participants in this study. Participants were excluded if they had neuromuscular or musculoskeletal disorders, pain, or a limited range of motion that could affect the performance of the tasks in the study.

We used an independent measures design with between and within-group measures to assess the effects of training with RobUST. Subjects were divided into three groups: (i) control group (Ctrl) which performed training without robotic assistance, (ii) trunk assistance group (T) which received robotic assistance at the thorax during training, and (iii) trunk-pelvis assistance group (T-P) which received robotic assistance both at the thorax and pelvis during training. Participants were randomly assigned to one of the three groups upon arrival. The study was conducted in a single session that lasted between 2 and 3 hours. All subjects underwent three research phases during the session: pre-training assessment, training with group-specific robotic assistance, and post-training assessment. A total of 24 participants (15 men, 9 women) were enrolled in the study: Height: 1723±108 mm, Weight: 70±16 kg, Age: 26±5 yrs.

Instrumentation: A nine-camera VICON motion capture system (Vicon, Denver, CO) was used to record kinematic data. Participants were instrumented with a 54-point retroreflective marker set. This study was carried out with participants standing on two six-axis force plates (Bertec, Columbus, OH), one underneath each foot. This yielded ground reaction forces and the location of the center of pressure for each foot on the force plate. The experimental setup is shown in FIGS. 1a and 1b. It includes the VICON motion capture system 70 with reflective markers, force platforms 60 for assessing balance and loading, a screen 80 for visual feedback, and the robotic system equipped with belts 50 providing forces at both the thorax and pelvis.

Pre- and Post-Training Assessments: The pre-training assessments were conducted to evaluate participants' baseline functional performance, while the post-training assessments measured changes resulting from the training. These assessments were chosen to measure a combination of upper and lower extremity reach capability of the participants, dynamic trunk control, and balance. The tests included the Functional Reach Test, Y Balance Test, Star Test, and Ellipse Trace Test, each offering complementary insights into participants' movement control and coordination. Participants maintained a shoulder-width stance throughout all sessions, with foot positions marked and monitored for consistency.

The combination of discrete tasks, such as reaching, and continuous tasks, such as ellipse-tracing, enables a more comprehensive assessment of changes in motor performance attributable to training. The Functional Reach Test and Y Balance Tests evaluate gross motor control and dynamic balance. Additionally, the Star Test and Ellipse Trace Test capture fine aspects of trunk coordination and control. These measures align well with the study goals of improving trunk movement through robot-assisted training and transferability to other functional tasks.

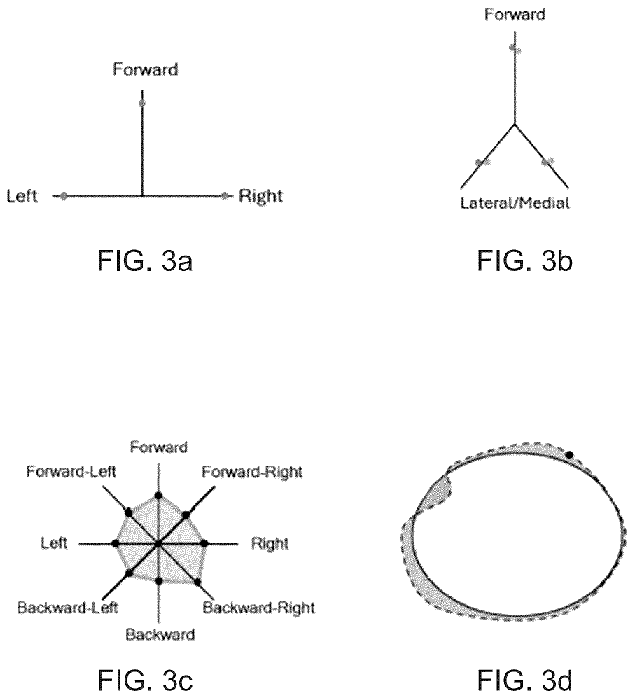

Functional Reach Test: The Functional Reach Test (FRT) is a well-established measure of dynamic balance and stability, assessing an individual's ability to maintain a stable base of support while reaching with the arm. FIG. 3(a) depicts the Functional Reach Test, in which participants reached as far as possible with their hand in three directions while maintaining a fixed base of support. Participants performed forward and sideways reaches, each repeated three times, while standing with a fixed base of support. The outcomes of interest are the maximum reach distances of the hand in each direction. These dynamic reach tests have been shown to correlate with fall risk and to reflect overall postural control, making them relevant in the context of trunk training and also in the context of rehabilitation.

The FRT was conducted in three positions: (i) with the right hand in the forward direction, (ii) with the right hand in the right direction, and (iii) with the left hand in the left direction. Participants received visual feedback on a screen that displayed the position of the wrist retroreflective marker on the reaching arm. To conduct the test, a subject extended their arm in the reach direction, making a 90-degree angle with the torso while standing upright. A horizontal reaching plane in which the participants would reach was established at this height and was displayed as a line in the reaching direction on the screen. Subjects were then asked to move as far in the reaching direction as they could without lifting their feet or touching anything for support. The furthest point reached along the horizontal reaching line during each trial was displayed along with the wrist's real-time position. The subjects were able to move this furthest-reach point forward only when they were within 20 mm of the reaching line. Three trials were performed in each direction, and the furthest point reached during the trial was recorded.

Y Balance Test: The Y Balance Test evaluates dynamic lower limb stability and balance control by requiring participants to reach in three directions with one foot while standing on the other foot. FIG. 3(b) depicts the Y Balance Test, involving maximal reach with each foot in three directions. The maximum reach distance in each direction was recorded and then scaled as a percentage of the subject's leg length.

The Y Balance Test was included to assess the participant's ability to coordinate lower-extremity movements with postural control strategies. This test is widely used in sports science and rehabilitation due to its sensitivity to balance asymmetries and its predictive value for injury risk and functional deficits.

Star Test: The Star Test is a custom-designed assessment in which participants reach with their thorax in the eight directions (Forward, Forward-Right, Right, Backward-Right, Backward, Backward-Left, Left, Forward-Left) while maintaining a fixed and stable base of support (see FIG. 3(c)). Each direction was tested three times, with the order of directions randomized to minimize learning effects. This test was specifically developed for this study to evaluate multidirectional trunk movement and control. Unlike standard reach tests, the star test captures the interplay between trunk range of motion, coordination, and stability in different directions.

Ellipse Trace Test: The Ellipse Trace Test required participants to trace an elliptical trajectory using their thorax. FIG. 3(d) depicts the Ellipse Trace Test, in which participants followed a planar trajectory with their thorax as closely as possible while keeping a fixed base of support. The path was a compound ellipse constructed by combining the quadrants of four individual ellipses and centered on the participant's neutral thorax position. To tailor the task to each individual's range of motion, the major and minor axes of each quadrant were determined based on the participant's maximum reach distances in the corresponding directions, as recorded during the Star Test described above. These reach values established the baseline dimensions of the elliptical path. A scaling ratio was then applied to resize the ellipse at different points during the test, enabling progressive changes in difficulty. Specifically, participants were asked to follow the elliptical path with their thorax at four different ellipse scaling ratios: 60%, 80%, 90%, and 100%. Each path was tested five times in the clockwise direction. The participants were instructed to trace the ellipse as quickly and as accurately as possible. Visual feedback was provided in real-time, allowing subjects to see the current position of their thorax center and the target path to be followed.

This test was included to measure fine motor control and dynamic coordination of the trunk during a continuous movement task. By incorporating paths at different fractions of the maximum static reach, the test allowed for assessment of the participants' ability to execute both small and large ellipse thorax movements. Such continuous tracking tasks have been shown to be effective for assessing sensorimotor integration and control in humans.

Training Intervention: Training was conducted using the ellipse tracing task. During the intervention phase, participants were asked to follow a pacer on the screen that moved at a preselected speed along the compound ellipse. The visual feedback included real-time position of their thorax center displayed as a square dot in a 2D horizontal plane, and the entire elliptical path.

FIG. 2(b) is a planar representation of the ellipse trace training exercise. The elliptical trajectory, which participants were instructed to follow with their thorax, was defined based on the individual's maximum reach distances in the four main directions during the Star Test. A circular planar force field acting on the thorax (thorax and pelvis) was applied during the training in the Trunk (Trunk-Pelvis) assistance group. Participants were considered to be accurately tracking the pacer when they stayed within a heuristically determined distance of 30 mm of the pacer. The accuracy score for each lap around the ellipse was defined as:

$$\frac{Time spent within target area}{Total lap time} \times 100 \qquad ( 1 )$$

The pacer's speed was set so that it would go around one lap of the unscaled elliptical path in 25 seconds. This speed was maintained through all the tests and interventions. At the beginning of the training, the ellipse scaling ratio was set to 80%. The scaling ratio was dynamically adjusted during training based on performance according to the following rule: If the average accuracy of two consecutive laps exceeds 80%, the ellipse scaling ratio is increased by 2.5%. If the average accuracy falls below 50% for two consecutive laps, the scaling ratio is decreased by 2.5%. This adaptive approach ensured that the task difficulty was tailored appropriately to suit the performance of each participant.

### Robotic Assistance

The Ctrl group in this study did not receive robotic assistance, while for T and T-P groups assistance was provided by RobUST.

RobUST: The Robotic Upright Stand Trainer used in this study has been previously described in detail. See, e.g., C. D. Bowersock et al., “Robotic Upright Stand Trainer (RobUST) and Postural Control in Individuals with Spinal Cord Injury,” J. Spinal Cord Med., vol. 46, no. 6, pp. 889-899 (November 2023); and M. Khan et al., “Stand Trainer with Applied Forces at the Pelvis and Trunk: Response to Perturbations and Assist-as-Needed Support,” IEEE Trans Neural Syst Rehabil Eng 2019 27 (9): 1855-1864. Each of those articles are incorporated herein by reference in its entirety. The RobUST device consists of an aluminum frame with 12 mounted motors (Maxon Motor, Switzerland) for controlling forces applied by cables routed from the motors through pulleys and connected to dedicated harnesses at the thorax and pelvis. Cables are attached to four points on the belt. Four cables attach at the thorax and eight cables at the pelvis (see FIG. 1b). The T group received assistance only at the thorax, and the T-P group received assistance at both the thorax and pelvis.

Trunk Assistance: Trunk assistance was implemented as a force applied to the thorax, pulling the subject's thorax center toward the pacer. Three concentric regions were defined around the pacer's position (see FIG. 2(b)))—Target area: a circular region with a 30 mm radius centered on the pacer position; Intermediate area: the annular region between the inner circle (30 mm) and an outer circle with a 60 mm radius; Outer area: the region beyond the 60 mm radius. The magnitude of the applied force F was determined by the distance d between the thorax center and the pacer position, according to the following rule:

$$where F = \{ \begin{matrix}0 , & if d \leq 30 \\ \frac{d - 30}{30} , {F}_{max} , & if 30 < d \leq 60 \\ {F}_{max} , & if d \geq 60\end{matrix} \qquad ( 2 )$$

$$d = ‖ thorax center position - pacer position ‖ \qquad ( 3 )$$

$$F max = 10 \% \times BW \qquad ( 4 )$$

with BW representing body weight.

In summary, no force was applied when the thorax center was within the inner circle; a linearly increasing force was applied in the intermediate area; and the maximum force was applied beyond the outer circle.

Mathematical Model of Thorax-Pelvis Relationship: A regression model relating thorax position to pelvis position was used during the ellipse tracing task in training sessions for the T-P group. The regression coefficients were derived from movement data collected in a prior study with 18 participants. In this experiment, each participant's maximum excursion and ellipse-tracing trajectory were established using the Star Test described above. Participants were then asked to trace ellipses at 40%, 60%, and 80% ellipse scaling ratios. Each movement was performed five times at two speeds: a slow speed, approximately equal to (circumference of the 100% ellipse)/10s, and a fast speed, equal to (circumference of the 100% ellipse)/8s. A linear regression model was fitted to relate the three-dimensional trunk position, the participant's height, and the ellipse scaling ratio to the three-dimensional pelvic position. The model yielded R² values of 80.65%, 78.76%, and 88.36% for predicting pelvic position along the x-, y-, and z-axes, respectively.

Trunk-Pelvis Assistance: Participants in this condition received assistance at both the thorax and the pelvis. Trunk assistance was the same as described above in connection with FIG. 2(b). Pelvis assistance was a force on the pelvis that pulled the participant towards the pelvis' regression-predicted location, as described in the previous section. The force magnitude was determined in a similar way to that for trunk assistance, with the inner and outer radii set to 20 mm and 50 mm, respectively, and the maximum force set at 15% of the subject's body weight. This percentage was chosen to assist movement toward the stability boundary while avoiding discomfort.

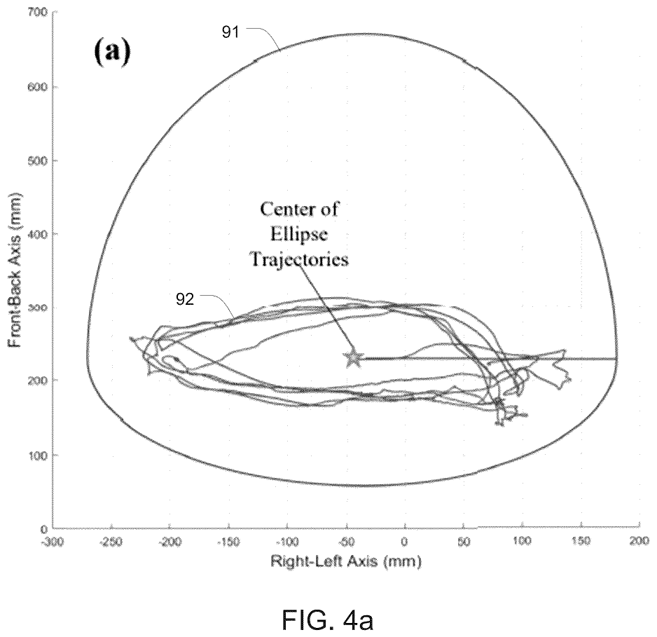

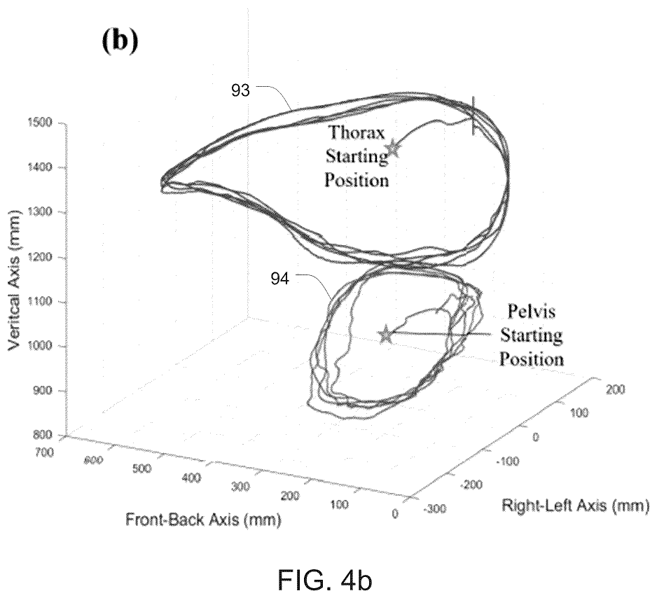

FIGS. 4(a) and 4(b) depict the thorax-pelvis regression relationship for a single subject. More specifically, FIG. 4(a) is the prescribed thorax trajectory in the horizontal plane (trace 91), defined by the compound ellipse derived from the subject's maximum excursion in the cardinal directions during the star test. The corresponding prescribed pelvis trajectory (trace 92) was derived from a regression relationship using the thorax trajectory and the real-time vertical position of the thorax as inputs. FIG. 4(b) shows the thorax trajectory in the horizontal plane combined with the real-time thorax vertical position (trace 93), and the resulting prescribed pelvis trajectory, computed using the regression model (trace 94).

Variables Measured and Evaluated: The positions of body segments, including the feet, legs, pelvis, thorax, shoulders, and arms, were recorded during the experimental sessions, with specific variables analyzed during each phase of the experiment. During the FRT, the maximum excursion of the wrist, normalized by the arm length of each participant, was measured and evaluated. Similarly, in the Y balance test, the position of the tip of the reaching foot normalized by leg length was assessed. For the star test, the maximum thorax excursion along each of the directions was recorded, as well as the pelvis excursion. The smoothness of both the thorax and pelvis movement were evaluated using the log dimensionless jerk (LDLJ). These measures were also evaluated for the ellipse trace test.

Ellipse accuracy/error of this test was defined as the average deviation of the traced trajectory from the elliptical path over all trials:

$$\sum all frames ( Distance of trunk to ellipse each frame ) \div Frame count \qquad ( 5 )$$

Furthermore, the smoothness of thorax and pelvis trajectories during the star and ellipse trace tests was assessed using the LDLJ metric.

The continuous relative phase (CRP) relationship between the thorax and pelvis was evaluated using their mediolateral (X-axis) positions during the ellipse-tracing task. The CRP method projects cyclic movements onto a unit circle by combining segment displacement and velocity, yielding a circular phase representation of motion. From this representation, the instantaneous phase difference between the thorax and pelvis can be quantified. We computed the mean and standard deviation (std) of the CRP of the thorax-pelvis displacement in the mediolateral direction to characterize the average coordination and variability of their relative motion.

The ellipse scaling ratio changed through the 96 trials of the training session according to the subject's performance. This evolution was recorded and evaluated. It was used as an indicator of motor skill improvement during training, and the maximum scaling ratio value indicated how much improvement the participant had achieved. The ratio was normalized by subject height as a way to account for differing anthropometrics.

To evaluate the learning rate of the subjects, the ellipse scaling ratio's evolution was modeled with a learning curve represented as the logistic function

$$y ( t ) = \frac{A}{1 + {e}^{-} \text{?} \text{?}} \qquad ( 6 )$$

$$\text{?} \text{indicates text missing or illegible when filed}$$

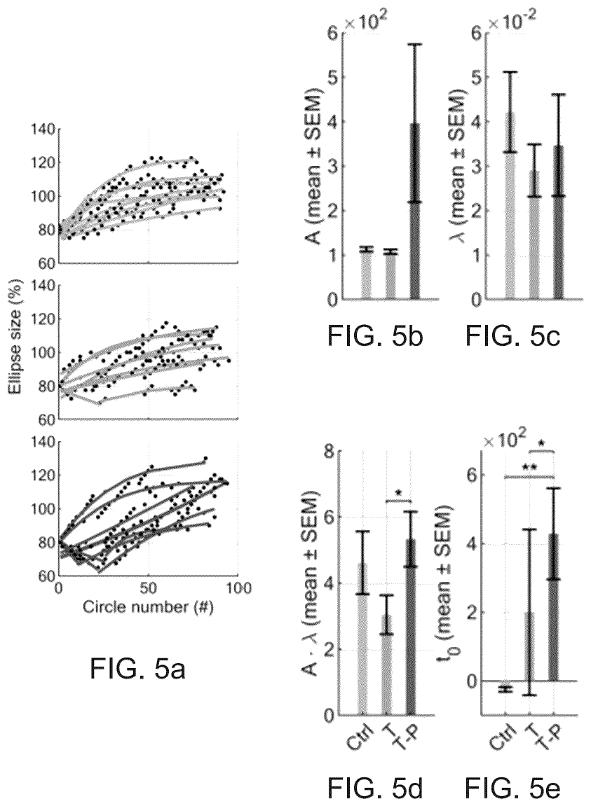

In this model, the ellipse scaling ratio was sampled once per training trial, giving a set of discrete data points. The logistic function provides a smooth, continuous curve that approximates the trend of these data, where the variable t represents training time. The asymptotic value A corresponds to the plateau level, reflecting the subject's maximum stable performance. The parameter λ determines the steepness of the curve around the inflection point, describing the rate at which performance improves (i.e., the learning rate). The parameter t₀ marks the inflection point itself, i.e., the effective “time” in training at which learning is fastest. The fitted learning curves are shown for all subjects in FIG. 5(a), which shows the learning curves fitted to the sizes of ellipses during training for subjects from the control (Ctrl, top panel), trunk (T, middle panel), and trunk-pelvis (T-P, lower panel) groups.

If the initial fit was poor (R² below a predefined threshold), the first portion of the data was instead fitted with a linear model. The learning plateau was defined as the point on the learning curve where the slope dropped below a specified threshold.

Statistical Analysis: All statistical analyses were conducted using MATLAB (Mathworks, Natick, MA, USA). The primary objective of the analysis was to evaluate the effects of time (pre-vs. post-test) and group (three experimental conditions) on the dependent variables. Prior to conducting parametric tests, the normality of each dependent variable was assessed using the Shapiro-Wilk test, and the homogeneity of variances was examined using Levene's test. Outliers were identified and removed independently within each condition using MATLAB's isoutlier function, ensuring that extreme values in pre-test and post-test data were excluded separately. Most dependent variables satisfied the assumptions (normality and homogeneity), and so we performed a two-factor ANOVA with Group (3 levels) and Time (2 levels: Pre vs Post). This mixed ANOVA examined the main effects of Group (differences among the three training groups overall) and Time (pre-vs. post-training change across all subjects), and the Group×Time interaction (whether the change over time depended on group). We report significance at α=0.05 for these effects. For variables that showed a significant time effect, post-hoc comparisons were performed within each group using paired t-tests (for ANOVA) or Wilcoxon signed-rank tests (for the non-parametric approach). The normality of the data distributions for the metrics extracted from the logistic fit was assessed using the Lilliefors test. Pairwise comparisons between the three experimental groups were conducted using independent t-tests (if both groups met the normality assumption) or the Wilcoxon rank-sum test (if at least one group deviated from normality).

### Results

### Training

Due to the challenge-point-based method used to update the ellipse size during training, the final ellipse size after 96 ellipse trials varied across subjects. On average, the T-P group reached 109%=14.45 of their baseline ellipse size, the Ctrl group reached 107.5%=8.66, while the T group reached 102.5%=11.2.

To account for individual differences in base of support, final ellipse scaling ratios were normalized by each subject's height. A one-way ANOVA revealed significant group differences in the normalized final ellipse sizes (F(2, 23)=5.06, p=0.016). Post-hoc comparisons with Bonferroni correction showed that the T-P group had significantly higher normalized ellipse sizes than the T group (p=0.010). No significant differences were found between the T and Ctrl groups (p=0.022) nor between Ctrl and T-P (p=0.241).

The training data were well-fitted by the model described by Eq. 6, with an average R² of 0.92±0.07, except for a single outlier in the T group. Some subjects in the assisted groups exhibited an initial decline in performance, notably, three in the T-P group and one in the T group. The learning plateau was reached by three subjects in the Ctrl group.

FIGS. 5(b)-5(e) depict various parameters for the control, trunk, and trunk-pelvis groups; and those three groups are represented by respective bars (moving from left to right) in each of those figures. (Significant group differences are indicated in these figures as follows: *p<0.05, **p<0.01.) While the T-P group exhibited a higher average asymptotic value A, this difference was not significant (FIG. 5(b)). There was no statistical difference in learning rates λ across the three groups (FIG. 5(c)). However, the T-P group showed a statistically higher A·λ (p<0.05), a metric that combines learning speed and asymptotic performance, reflecting overall learning effectiveness (FIG. 5(d)). Additionally, the inflection point (to) (extracted from the logistic fits across groups (mean±SEM) was significantly higher in the T-P group compared to the T (p<0.05) and Ctrl (p<0.01) groups (FIG. 5(e)).

### Two-Way ANOVA Results

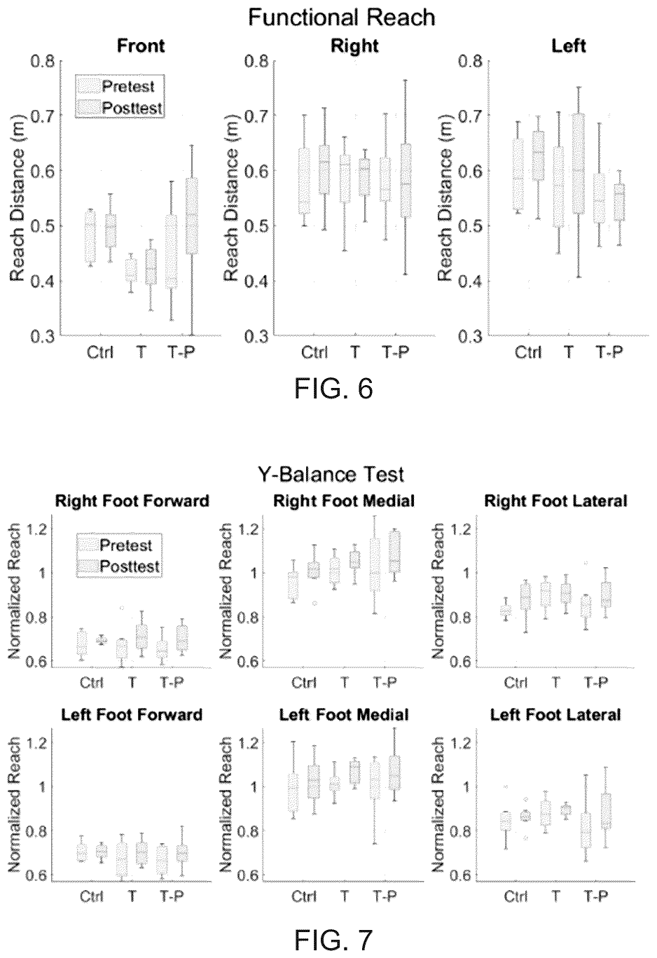

A two-way ANOVA was used to determine the main effects of group (Ctrl, T, or T-P), the training effect, and the interaction effect. Note that in FIGS. 6-9, each label on the X axis corresponds to a PAIR of data bars. And within each of those pairs, the data bar on the left corresponds to the pre-test data, and the data bar on the right corresponds to the post-test data.

Functional Reach: These results are reported in FIG. 6. The two-way ANOVA with outlier removal for the front reach revealed no group main effect, and no time or interaction effects.

Y Balance Test: Statistical analysis of the Y Balance test revealed no main or interaction effects. Subjects demonstrated the greatest reach when performing the medial leg extensions and the least reach when performing the forward leg extensions, as shown in FIG. 7. The Y-axis values in FIG. 7 are the normalized reach distance calculated by dividing the target foot's average maximum displacement over three trials by the subject's leg length.

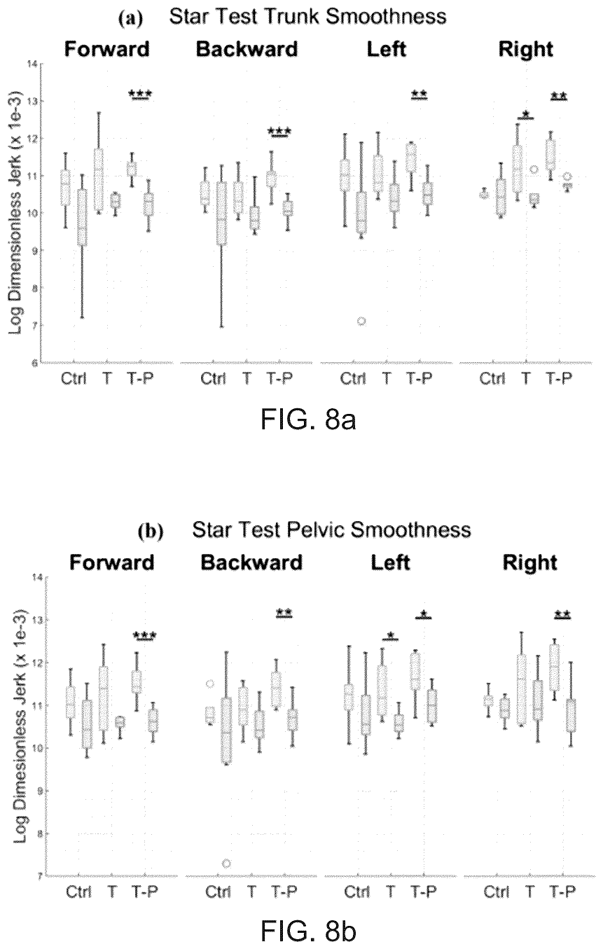

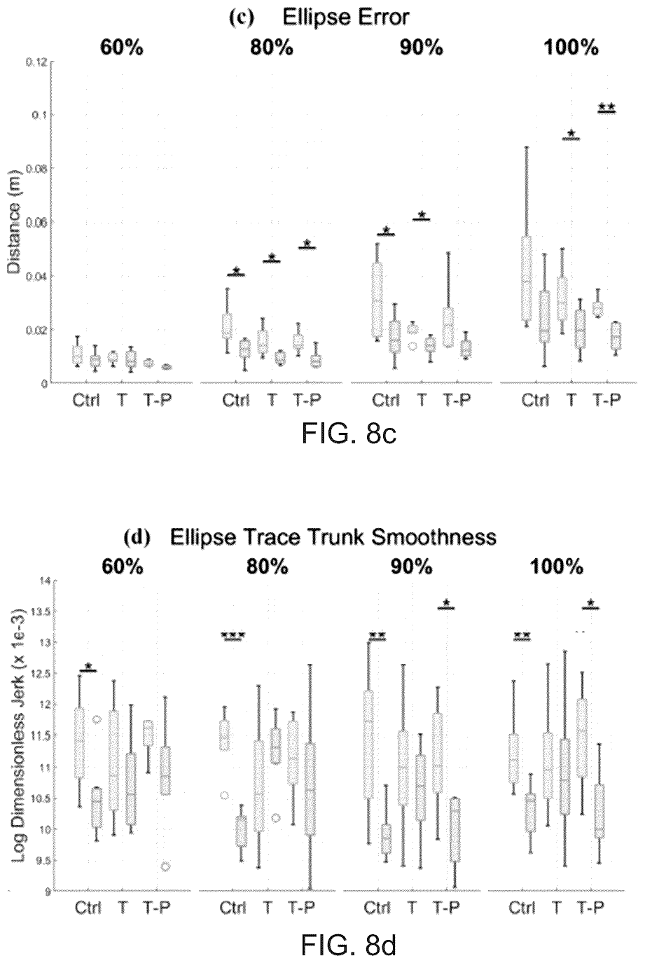

Star Test: The thorax excursion was measured during the star test. A main effect of time was observed in the left and left-back directions [(F(1, 44)=11.27, p=0.002, partial η²=0.22), [(F(1, 44)=6.07, p=0.018, partial η²=0.13) respectively], and post-hoc tests revealed a significant increase in the T-P group (p=0.043, p=0.045, respectively) but not in the other groups or other directions. Analysis of pelvic excursion during the star test detected main effects of time in the back-left and back-right directions [(F(1, 40)=13.05, p<0.001, partial η²=0.27), [(F(1, 41)=11.22, p=0.002, partial η²=0.24) respectively], with post-hoc tests revealing increases between pre and post-test in the T-P group in both directions (p=0.041, p=0.044, respectively), and in the T group only in the back-right direction (p=0.028). The smoothness metric of the trajectory traced by the thorax, LDLJ, also had time main effects in all directions, with post hoc tests revealing increases in smoothness for the T-P group, as shown in FIGS. 8(a)-(d). Similarly, statistical analysis of the pelvis-traced trajectory produced main effects of time in all directions, with post hoc tests indicating increased smoothness in the T-P group.

Ellipse Tracing Test: T-P and Ctrl training resulted in an increase in the smoothness of the elliptical trajectory traced by the subjects, while T training did not. See FIG. 8(a) and(b), which show the average group smoothness of the trajectories traced by subjects' thorax FIG. 8(a) and pelvis FIG. 8(b) during the Star Test during the pre-test (left bar within each pair) and post-test (right bar within each pair). This change between pre- and post-tests was observed in the smoothness metric for the ellipse tracing task at 90% ellipse scaling ratio (F(1, 42)=9.09, p=0.005, partial η²=0.20) along with an interaction effect (F(2, 42)=3.32 p=0.047, partial η²=0.15). Smoothness increased for the T-P group trajectory (p=0.020) and for the Ctrl group (p=0.013) but not in the T group.

There was an interaction effect observed in the thorax smoothness metric at 80% ellipse scaling ratio in the Ellipse Tracing task (F(1, 40)=5.18, p=0.011, partial η^{2=0.23}). Post hoc analysis revealed that the smoothness of the Ctrl group trajectories increased (p<0.001), while there was no significant change in the T and T-P groups.

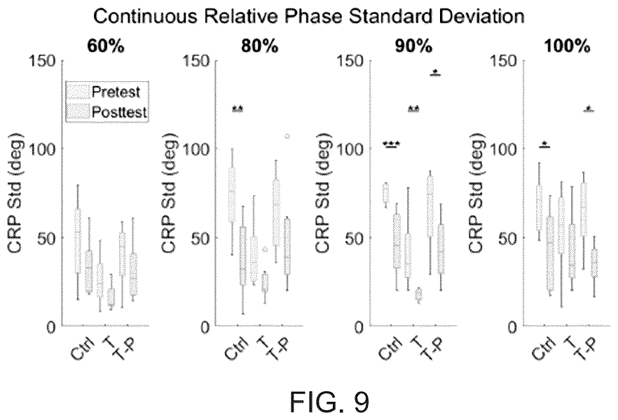

No significant changes to the mean CRP were observed between the pre- and posttests. There were significant decreases in the CRP std of the posttests of the Ctrl group at the 80%, 90%, and 100% scaling ratios, in the T group at the 90% scaling ratio, and in the T-P group at the 90% and 100% scaling ratios (FIG. 9).

In addition to these results, we observed the following as displayed in FIGS. 8(c)-(d) and 9.

60% Ellipse—No significant changes were observed in ellipse accuracy, ellipse time, or CRP std.

80% Ellipse—Main effects of time were observed in the following measurements: Ellipse accuracy (F(1, 40)=20.10, p<0.001, partial η²=0.36), and ellipse time (F(1, 39)=5.53, p=0.025, partial η²=0.14) FIG. 8(c). Post hoc tests revealed pre-post changes in all three groups for the ellipse accuracy measurements (p=0.003, p=0.002, p=0.004) (p=0.011, p=0.014, p=0.035) and a significant decrease in ellipse time was only observed for the Ctrl group (p=0.005). Main effects of group and time were observed in the CRP std (F(1, 46)=6.51, p=0.004, partial η²=0.24, and F(1, 46)=14.37, p<0.001, partial η²=0.26). Post-hoc tests revealed a reduction in the CRP std of the Ctrl group (p=0.0035), without any significant changes to the T and T-P groups.

90% Ellipse—A main effect of time was observed in ellipse accuracy (F(1, 40)=12.32, p=0.001 partial η²=0.26), and ellipse time (F(1, 40)=8.29, p=0.007 partial η²=0.19) measurements but not in the path length FIG. 8(c). Post-hoc tests revealed significant increases in mean accuracy for the Ctrl (p=0.030) and T (p=0.012) groups and a significant decrease in ellipse time in the Ctrl (p=0.022) group. Main effects of group and time were observed in the CRP std (F(1, 46)=16.62, p<0.001, partial η²=0.45, and F(1, 46)=28.79, p<0.001, partial η²=0.41). Post-hoc tests revealed a reduction in the CRP std of the Ctrl group (p<0.001), the T group (p=0.007), and the T-P group (p=0.030).

100% Ellipse—There were main effects of time in ellipse accuracy (F(1, 41)=10.52, p=0.003 partial η²=0.23), and ellipse time (F(1, 40)=5.61, p=0.024 partial η²=0.14) measurements but not in the path length. Post hoc tests revealed increases in accuracy for the T and T-P groups (p=0.029, p=0.007, respectively), and a decrease in ellipse time for the Ctrl group (p=0.025). A main effect of time was observed for CRP std (F(1, 43)=13.65, p<0.001, partial η²=0.26). Post-hoc tests revealed a reduction in the CRP std of the Ctrl group (p<0.020), and the T-P group (p=0.014).

Many of these results are represented in FIGS. 8(c)-(d) and 9. More specifically, FIG. 8(c) shows the Ellipse Trace Accuracy/Error. Accuracy was determined as the average over the ellipse trace test of the distance from the thorax center to the prescribed elliptical path. This is the error in tracing the path. FIG. 8(d) shows the log Dimensionless Jerk smoothness of ellipse trace trajectory at several ellipse sizes. Significance levels: *p<0.05, **p<0.01, ***p<0.001. And FIG. 9 shows continuous relative phase (CRP) standard deviation at 60%, 80%, 90% and 100% ellipse scaling ratios. Significance levels: *p<0.05, **p<0.01, ***p<0.001.

### DISCUSSION

This study investigated the effects of three training paradigms on postural stability and reach performance, as well as the potential benefits associated with these interventions. We demonstrated that: 1) thorax-pelvis assistance during training allowed participants to reach further than those with trunk-only assistance, though not significantly farther than the Control group; 2) the trajectories traced by the participants in T-P training became smoother after training, and 3) ellipse tracing accuracy improved across all training modes.

A key finding was that participants in the T-P group executed larger ellipse sizes during training than the T group, suggesting that pelvic support enabled them to explore and execute a larger range of motion without compromising stability. At the start of training, subjects in both the T and T-P groups underwent an acclimatization period, during which their performance on the ellipse tracing task was low. This interpretation is supported by the analysis of the learning curves. Specifically, a subset of subjects in the assisted groups (three in T-P and one in T) showed an initial decline in ellipse scaling ratio, consistent with the observed acclimatization period. However, once the subjects adapted to RobUST, their performance improved, as demonstrated by the increase in the ellipse scaling ratio. In contrast, the Ctrl group did not undergo an acclimatization period, allowing them to show improvement from the beginning. Notably, the ellipse scaling ratio plateaued only in the Ctrl group, suggesting that their progress reached a ceiling during the training period. The T-P group eventually matched the Ctrl group's rate of ellipse scaling, but the T group did not. In fact, the combined learning metric (A·λ) was significantly larger in T-P than in T, suggesting that pelvic assistance may lead to more effective overall learning. Furthermore, the inflection point (t₀) occurred significantly later in T-P compared to both Ctrl and T, indicating that assisted subjects required more practice to reach their fastest learning phase. Together, these results reinforce the idea that pelvic support facilitates greater exploration and long-term gains, but at the cost of a slower initial adaptation.

The second notable finding was that the LDLJ measure of smoothness for the 90% Ellipse Tracing post-test improved for the T-P and control groups but not for the T group. Movement smoothness results from effort minimization and is related to motor learning and spatiotemporal coordination, and thus higher smoothness indicates greater control in executing motion along a path. The higher smoothness of the T-P group compared to the T group could be due to several factors. The T-P group could have adopted a balance strategy that facilitates smoother bending as a result of the training. We did not identify balance strategies in this study, but we measured coordination between the trunk and pelvis using the continuous relative phase metric. There were no significant changes to the average cycle CRP, but the CRP standard deviation decreased with training. This standard deviation measures the variability of the phase difference between the segments over a cycle. In practical terms, low CRP variability indicates a stable, repeatable coordination pattern, whereas high CRP variability indicates flexible or inconsistent coupling. Variability in CRP is often interpreted in the context of movement adaptability or neuromuscular control-too little variability may suggest a rigid strategy, while moderate variability can reflect healthy adaptability. All this suggests that with practice, subjects found movement trajectories that minimized changes in phase between the trunk and pelvis, as predicted by the effort minimization principle of learning. We believe that this stabilization of the CRP shows up as smoother trajectories (reduced LDLJ) in the Ctrl and T-P groups. Higher smoothness could also be due to improved muscle coordination in the T-P training which promoted movement of the pelvis during training.

Significant increases in ellipse-tracing accuracy between pre- and post-tests (FIG. 9) indicate the effectiveness of the training paradigm. The large ellipse tracing tasks, at 90% and 100% levels, showed a large increase in accuracy because subjects were unable to trace ellipses that wide at the beginning of the experiment. After training, their accuracy greatly improved. In addition, the smoothness of the trajectory of the traced ellipses improved.

Post hoc analyses of time effects without interaction revealed additional improvements. In the Star test, we found an increase in smoothness of the trunk and pelvis trajectories in all directions for the T-P group, but not in the other groups. The T-P group trajectories thus got steadier after training. This result re-emphasizes that T-P training results in smoother movement.

A central implication of these findings is the contrast between the two robotic assistance modes. Although both groups trained with RobUST, only the combined trunk-pelvis assistance yielded clear improvements in reach and smoothness. Pelvic involvement likely enabled participants to explore a wider range of motion without losing balance, promoting more effective motor learning. In contrast, trunk-only assistance may have constrained natural coordination strategies, providing less stabilization and leading to smaller gains. This distinction suggests that the location and distribution of robotic assistance are critical design factors for balance training.

A previous study using RobUST demonstrated that when typically developing participants received active pelvic assistance, the system facilitated hands-free balance training and encouraged weight bearing in the lower limbs, an essential component of SCI rehabilitation, without restricting natural pelvic motion. C. D. Bowersock et al., “Robotic Upright Stand Trainer (RobUST) and Postural Control in Individuals with Spinal Cord Injury,” J. Spinal Cord Med., vol. 46, no. 6, pp. 889-899 (November 2023) further demonstrated that, in individuals with SCI, training with RobUST in a configuration providing passive pelvic locking support improved participants' ability to maintain steady standing, initiate voluntary trunk movements, and increase load bearing through the legs.

Building on these findings, the present study introduces a novel training paradigm designed to facilitate coordinated movement of the trunk and pelvis. Our results indicate that coordinated trunk-pelvis assistance enabled participants to achieve the greatest reaching distances. Moreover, participants trained with trunk-pelvis assistance outperformed those trained with trunk-only assistance in post-training evaluations, exhibiting improved trajectory smoothness.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An apparatus for teaching a person how to move their body in a particular way, the apparatus comprising:
a plurality of first cables;
a first fastener configured to fasten the plurality of first cables to the person's pelvis;
a plurality of first actuators, each of which is configured to, when actuated, exert a pull force on a respective one of the first cables;
a plurality of second cables;
a second fastener configured to fasten the plurality of second cables to the person's torso;
a plurality of second actuators, each of which is configured to, when actuated, exert a pull force on a respective one of the second cables; and
a controller configured to generate a sequence of commands that results in a synchronized actuation of the plurality of first actuators and the plurality of second actuators,
wherein the synchronized actuation of the plurality of first actuators and the plurality of second actuators causes corresponding synchronized pull forces to be applied to the plurality of first cables and plurality of second cables, respectively,
wherein the synchronized pull forces applied to the plurality of first cables and the plurality of second cables cause corresponding synchronized forces to be applied to the first fastener and the second fastener, respectively,
wherein the synchronized forces applied to the first fastener and the second fastener cause corresponding synchronized forces to be applied to the person's pelvis and the person's torso, respectively, and
wherein the sequence of commands is selected so the forces applied to person's pelvis and the person's torso help teach the person how to move their body in the particular way.

2. The apparatus of claim 1, wherein the plurality of first actuators comprises a plurality of first motors, and wherein the plurality of second actuators comprises a plurality of second motors.

3. The apparatus of claim 1, further comprising a first force plate configured for positioning beneath a first foot of the person,
wherein the first force plate generates first data that is routed to the controller, and
wherein the controller is further configured to modify the generated sequence of commands based on the first data.

4. The apparatus of claim 1, further comprising:
a first force plate configured for positioning beneath a first foot of the person; and
a second force plate configured for positioning beneath a second foot of the person,
wherein the first force plate generates first data that is routed to the controller,
wherein the second force plate generates second data that is routed to the controller, and
wherein the controller is further configured to modify the generated sequence of commands based on the first data and the second data.

5. The apparatus of claim 1, wherein the sequence of commands is selected so the forces applied to the person's pelvis and the person's torso will help the person learn how to do a particular task that requires coordination of the person's upper body and the person's lower body.

6. The apparatus of claim 1, wherein the sequence of commands is selected to provide assist-as-needed forces to the person's pelvis and the person's torso, wherein the assist-as-needed forces help the person learn how to do a particular task that requires coordination of the person's upper body and the person's lower body.

7. The apparatus of claim 1, wherein the sequence of commands is selected so the forces applied to person's pelvis and the person's torso will help the person learn how to do a particular sport-related task.

8. The apparatus of claim 7, wherein the sequence of commands is selected to progressively increase the task's difficulty over time within a single training session.

9. The apparatus of claim 7, wherein the sequence of commands is selected to progressively increase the task's difficulty over a plurality of training sessions.

10. The apparatus of claim 1, wherein the sequence of commands is selected so the forces applied to the person's pelvis and the person's torso will help the person learn how to do a particular yoga move.

11. A method of training a subject to perform a particular task, the method comprising:
creating a first motion template of the pelvic and trunk centers of a plurality of experts while they perform the particular task;
recording movement patterns of the subject's pelvis and the subject's trunk while the subject performs the particular task; and
training the subject to coordinate their trunk and pelvis motions by providing assist-as-needed forces on the subject's pelvis and the subject's trunk,
wherein the assist-as-needed forces are based at least in part on the first motion template and the recorded movement patterns of the subject's pelvis and the subject's trunk.

12. The method of claim 11, further comprising comparing pre-training and post-training movements of the subject's pelvis and the subject's trunk to quantify the subject's learning.

13. The method of claim 11, further comprising:
creating a second motion template of at least one additional reference point on the bodies of the plurality of experts while they perform the particular task; and
recording movement patterns of the at least one additional reference point while the subject performs the particular task,
wherein the assist-as-needed forces are based at least in part on the second motion template and the recorded movement patterns of the at least one additional reference point.
